(19) United States
(12) Patent Application Publication
(10) Pub. No.: US 2017/0068758 A1
(43) Pub. Date: Mar. 9, 2017

(54) Project Management Simulator

(71) Applicant: HALLIBURTON ENERGY SERVICES, INC., Houston, TX (US)

(72) Inventors: Andrew John CUTHBERT, Spring, TX (US); Mary Anne GUINAN, Houston, TX (US); Ramesh K. RAGHUNATHAN, Katy, TX (US)

(73) Assignee: Halliburton Energy Services, Inc., Houston, TX (US)

(21) Appl. No.: 15/125,724

(22) PCT Filed: May 29, 2014
(86) PCT No.: PCT/US2014/040023

§ 371 Date: Sep. 13, 2016

(51) Int. Cl. G06F 17/50; G06F 9/44; G06Q 10/06; G06F 17/18

(52) U.S. Cl. CPC G06F 17/5009; G06F 17/18; G06F 9/4443; G06Q 10/0631

(57) ABSTRACT

A processor simulating a project management job receives through a GUI a subject matter (SME) selector indicating whether or not an SME has been selected. The processor receiving through the GUI a package selection for each of a plurality of package categories. The processor providing through the GUI a description of an event, the event being selected based on the package selections and a simulation stage, and descriptions of a plurality of options to respond to the event, wherein the plurality of options is based on the SME selector, the package selectors, and the simulation stage. The processor receiving through the GUI a selection of one of the plurality of options. The processor processing the option, the package selections, the SME selector, and the simulation stage to determine an outcome. The processor displaying the outcome on the GUI.

### BACKGROUND

Drilling and servicing oil wells can be an expensive and risky enterprise especially in light of unpredictability and complexity of such projects, the amount and variety of equipment available to perform such projects, and the need to make decisions in real time. Training project managers to make such decisions is challenge.

### BRIEF DESCRIPTION OF THE DRAWINGS

FIG. 1 illustrates a high level architecture diagram of a simulator according to aspects of one or more embodiments.

FIG. 2 illustrates a logical data model of a simulator according to aspects of one or more embodiments.

FIG. 3 illustrates a high level workflow for users of a simulator according to aspects of one or more embodiments.

FIGS. 4-18 are screen shots illustrating operation of a simulator according to aspects of one or more embodiments.

### DETAILED DESCRIPTION

In the field of project management for oil field services, and other project-oriented industries, there are a variety of scenarios to be accounted for through an analysis of the conditions under which well construction, intervention, control and/or temporary or permanent abandonment takes place. In one or more embodiments, a student (or user) can use interactive software, which accesses a database of selected scenarios, which can be modified, to practice the project management skills necessary to master control over a given Approval for Expenditure (AFE). Preparing cost estimates for an oil and/or gas well in the form of an AFE is the final step in well planning. The AFE is often accompanied by a projected payout schedule or revenue forecast. In one part of well planning, all the resources for drilling, completing, working over, contingency well planning in the event of a hydrocarbon influx, temporary plugging and permanent abandonment are taken into account. In one or more embodiments, the student considers dry holes and accounts for tangible and intangible items. In one or more embodiments, the student assesses which resources to purchase depending on the anticipated technical aspects of the projected well and whether bringing the resources to bear will affect the time required to drill, complete, control (in the case of an influx), temporarily abandon or permanently abandon the well.

In one or more embodiments, the major costs encompassed by an AFE include:
Projected drilling time
Time categories/time considerations
Location preparation
Drilling rig and tools
Drilling fluids
Cementing
Support services
Transportation
Supervision and administration (including subject matter experts (SMEs))
Tubulars
Wellhead equipment
Completion equipment
Well control and/or contingency spill equipment

In one or more embodiments, engineering considerations include:
Dry-hole and completed costs
Geological anomalies
Logical grouping, such as completion equipment or tubular goods
Contingency items, including relief well construction

In one or more embodiments, intangible costs include expenditures incurred for:
Labor
Contract management
Fuel
Repairs
Hauling
Supplies

In one or more embodiments, a simulator encompasses all the data sets required to enable the candidate to negotiate through Top hole, Intermediate hole and Reservoir sections in the course of well construction. In one or more embodiments, access to the simulator is via an online link to a main database or through a standalone version that is available for later synchronization with the main database for assessment and feedback purposes.

In one or more embodiments, the simulator will:
be controlled via a graphical user interface (GUI) including an iPAD version;
have administration functionality to create/administer training simulation data sets via direct online workflows;
have a set of core reports that provides summary and detail information on user training simulation sessions;
provide a randomization approach for cost assumptions/data so that each training simulation session is unique within the broad parameters of a specific data set;
have browse/edit functionality to master tables such as Event, Option, Item etc.;
have association/mapping functionality to associate master data items to a specific simulation data set;
have functionality to create, browse, edit, & delete a simulation data set;
have administrative functionality to map users to simulation data sets;
provide for Simulator Data Set Augmentation—additions of other information data sets;
provide a simulator summary table for any simulation (show the events, choices, cumulative P&L etc.) in a tabular formatted layout;
provide a user summary table of simulations undertaken (date, information data set, simulations, average profit and loss (P&L), time, and depth) with drill down to previous report i.e. simulations summary table;
produce a global summary table with drill down to previous report.

In addition, in one or more embodiments, administrative features include a reporting function with parameters/search filters—e.g. “Show all users who selected a particular option for all simulations with a negative (or positive) P&L.” Further, in one or more embodiments, user selections are recorded so that later analysis of the effectiveness of a particular user, a group of users, a simulation, or other combination of factors can be evaluated.

In one or more embodiment, the simulator includes models of cost distribution parameters including standard statistical distributions such as:
1. Constant distribution (min, max);
2. Normal distribution (mean, std. Deviation).

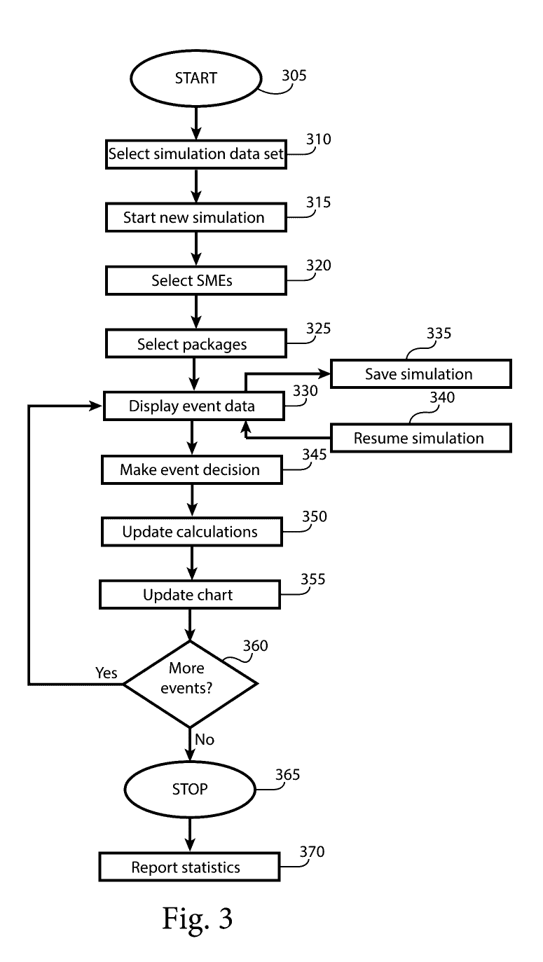

In one or more embodiment, each cost number is randomly picked when a new simulation is started per the distribution specified for each cost number and parameters. In one or more embodiments, the cost numbers are selected at the beginning of the simulation and each cost number is randomly adjusted at each package selection event, as discussed in connection with FIG. 3, and event decision, as discussed in connection with FIG. 3.

In one or more embodiments, the planned P&L for each simulation is based on user choices and these selected random values.

In one or more embodiments, the simulator includes a facility to add functionality by means of portals via which the simulator administrator is able to include technical updates to either the scenarios or technology referenced within the program. In one or more embodiments, the simulator includes portals to access real time data from company and external sources.

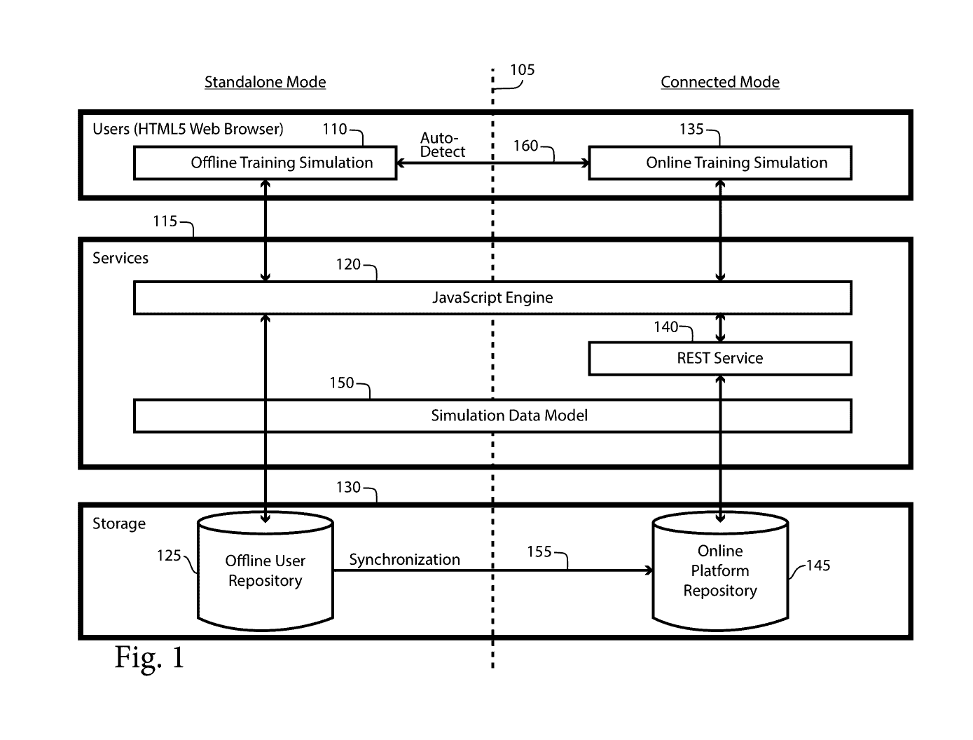

In one or more embodiments, illustrated in FIG. 1, the simulator operates in two modes: a “Standalone Mode” and a “Connected Mode.” The two modes are shown in FIG. 1 separated by dashed line 105.

In one embodiment, in the Standalone Mode, a user using, for example, an HTML5 web browser, accesses an offline training simulation 110. The offline training simulation 110 uses services 115, such as a JavaScript engine 120 to access an offline user repository 125 in a storage function 130.

In one or more embodiments, in the Connected Mode, a user using, for example, an HTML 5 web browser, accesses an online training simulation 135. In one or more embodiments, the online training simulation 135 accesses a representational state transfer (REST) service 140 through the JavaScript engine 120 to access an online platform repository 145.

In one or more embodiments, a simulation data model 150 provides a schema for accessing data stored in the offline user repository 120 and the online user repository 145.

In one or more embodiments, conventional means are used to synchronize the offline user repository 120 with the online platform repository 145 as indicated by line 155.

In one or more embodiments, the online training simulation 135 has an auto-detect feature indicated by line 160 through which offline training can be detected, which causes the synchronization function, represented by line 155, to be initiated.

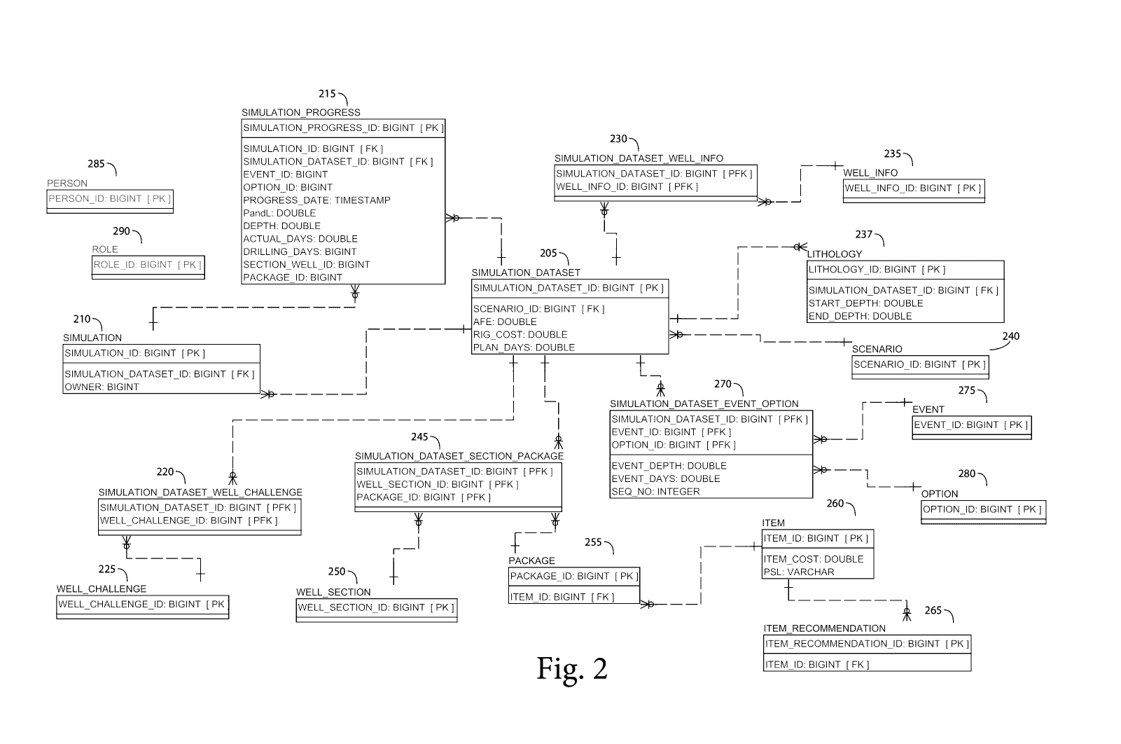

In one or more embodiments, the architecture of the simulator, illustrated in FIG. 2, is centered on a simulation_dataset 205. FIG. 2 uses “crow's foot” symbols, in which objects (where an “object” is a relation, a table, or another type of data structure) are connected by dashed lines having a crow's foot on one end and a single stroke at the other end. The crow's foot/slash symbols express a “one-to-many” relationship in which the “one” side is represented by the single stroke and the “many” side is represented by the crow's foot. For example, the simulation_dataset object 205 has a one-to-many relationship with a simulation object 210, which means that for each simulation_dataset object 205 there can be many simulation objects 210. FIG. 2 also uses “[FK],” “[PK],” and “[PFK]” symbols which represent “foreign key,” “primary key,” and “primary foreign key,” respectively. A foreign key of one object is linked to a primary key of another object. A primary foreign key has the primary key/foreign key relationship with the primary key of another object but is also a primary key of its object.

FIG. 2 describes a logical model for the relationship among the objects in the database and does not necessarily show all of the implementation details. In particular, some of the objects are shown with double lines at their bottom edges. The details of those objects are described in greater detail below or are not shown as they are not considered important for explaining the operation of the simulator, except as specifically mentioned herein.

Thus, in one or more embodiments:
each simulation_dataset object 205 can be linked to, and can be used to create, multiple simulation objects 210;
each simulation object 210 can be linked to, and tracked by, multiple simulation_progress objects 215;
multiple simulation_progress objects 215 can be linked to a simulation_dataset 205; the simulation_progress objects 215 are de-normalized (i.e., by being less parsimonious in data storage) to provide greater efficacy in data reporting;
each simulation_dataset object 205 can be linked to, and can present, multiple simulation_dataset_well_challenge objects 220;
each simulation_dataset_well_challenge object 220 can be linked to a well_challenge object 225, each of which can be linked to multiple simulation_dataset_well_challenge objects 220;
each simulation_dataset object 205 can be linked to multiple simulation_dataset_well_info objects 230;
each simulation_dataset_well_info object 230 can be linked to a well_info object 235, each of which can be linked to multiple simulation_dataset_well_info objects 230;
each simulation_dataset object 205 can be linked to multiple lithology objects 235;
each simulation_dataset object 205 can be linked to a scenario object 240, which can be linked to multiple simulation_dataset objects 205;
each simulation_dataset object 205 can be linked to multiple simulation_dataset_section_package objects 245;
each simulation_dataset_section_package object 245 can be linked to a well_section object 250, which can be linked to multiple simulation_dataset_section_package objects 245;
each simulation_dataset_section_package object 245 can be linked to a packages object 255, which can be linked to multiple simulation_dataset_section_package object 245;
each package object 255 can be linked to an item object 260, which can be linked to multiple package objects 255;
each item object 260 can be linked to multiple item_recommendation objects 265;
each simulation_dataset 205 can be linked to multiple simulation_dataset_event_option objects 270;
each simulation_dataset_event_option object 270 can be linked to an event object 275, which can be linked to multiple simulation_dataset_event_option objects 270;
each simulation_dataset_event_option object 270 can be linked to an option object 280, which can be linked to multiple simulation_dataset_event_option objects 270
each simulation is conducted by a person object 285; and
each person object 285 posses a set of roles, which are stored in a role object 290.

In one or more embodiments, the simulation_dataset object 205 has the following structure:

| Display Type | Type | Field Name |
|---|---|---|
| days | Text Field | days |
| simulation_dataset_description | Text Field | simulation_dataset_description |
| simulation_dataset_id | Text Field | simulation_dataset_id |
| simulation_dataset_name | Text Field | simulation_dataset_name |
| id | Text Field | field_id |
| Modified By ID | Text Field | modified_by_id |
| Owner ID | Text Field | field_owner_id |
| rig_cost | Number | rig_cost |
| Created By ID | Text Field | column1 |
| Created By | Lookup | created_id |
| Date Created | Date time | date_created |
| Date Modified | Date time | date_modified |
| Modified By | Lookup | modified_id |
| Object ID | Text Field | object_id |
| Owner | Lookup | owner_id |
| Record ID | Number | id |

In one or more embodiments, the simulation object 210 has the following structure:

| Title | Display Type | Field Name |
|---|---|---|
| simulation_dataset_id | Text Field | simulation_dataset_id |
| simulation_description | Text Field | simulation_description |
| simulation_id | Text Field | simulation_id |
| simulation_name | Text Field | simulation_name |
| id | Text Field | field_id |
| Modified By ID | Text Field | modified_by_id |
| Owner ID | Text Field | field_owner_id |
| Created By ID | Text Field | column1 |
| Created By | Lookup | created_id |
| Date Created | Date time | date_created |
| Date Modified | Date time | date_modified |
| Modified By | Lookup | modified_id |
| Object ID | Text Field | object_id |
| Owner | Lookup | owner_id |
| Record ID | Number | id |

In one or more embodiments, the simulation_progress object 215 has the following structure:

| Title | Display Type | Field Name |
|---|---|---|
| additinalcostcustomerupsell | Number | additinalcostcustomerupsell |
| currentActiveSimulation | Text Field | currentactivesimulation |
| dayslostgained | Number | dayslostgained |
| drillingdays | Number | drillingdays |
| eqptpkgcost | Number | eqptpkgcost |
| event_id | Text Field | event_id |
| firstUpdateInc | Text Field | firstupdateinc |
| simulation_dataset_id | Text Field | simulation_dataset_id |
| simulationdescription | Text Field | simulationdescription |
| simulationpassword | Text Field | simulationpassword |
| simulationuserid | Text Field | simulationuserid |
| simulation_id | Text Field | simulation_id |
| simulation_status | Text Field | simulation_status |
| id | Text Field | field_id |
| jobprofitability | Number | jobprofitability |
| measureddepth | Number | measureddepth |
| Modified By ID | Text Field | modified_by_id |
| option_description | Text Field | option_description |
| option_id | Text Field | option_id |
| Owner ID | Text Field | field_owner_id |
| package_id | Text Field | package_id |
| progress_dt | Text Field | progress_dt |
| projectbenefits | Number | projectbenefits |
| pslcollaborationpoints | Number | pslcollaborationpoints |
| rigspreadcostperday | Number | rigspreadcostperday |
| sectionPackageDetails | Text Field | sectionpackagedetails |
| section_id | Text Field | section_id |
| selectedEventNumber | Text Field | selectedeventnumber |
| targetafecost | Number | targetafecost |
| targetafedaysattd | Number | targetafedaysattd |
| totalactualdays | Number | totalactualdays |
| totalwellcost | Number | totalwellcost |
| Created By ID | Text Field | column1 |
| Created By | Lookup | created_id |
| Date Created | Date time | date_created |
| Date Modified | Date time | date_modified |
| Modified By | Lookup | modified_id |
| Object ID | Text Field | object_id |
| Owner | Lookup | owner_id |
| Record ID | Number | id |

In one or more embodiments, the simulation_dataset_well_challenge object 220 has the following structure:

| Display Type | Type | Field Name |
|---|---|---|
| simulation_dataset_id | Text Field | simulation_dataset_id |
| id | Text Field | field_id |
| Modified By ID | Text Field | modified_by_id |
| Owner ID | Text Field | field_owner_id |
| section_id | Text Field | section_id |
| wellchallenge_id | Text Field | wellchallenge_id |
| Created By ID | Text Field | column1 |
| Created By | Lookup | created_id |
| Date Created | Date time | date_created |
| Date Modified | Date time | date_modified |
| Modified By | Lookup | modified_id |
| Object ID | Text Field | object_id |
| Owner | Lookup | owner_id |
| Record ID | Number | id |

In one or more embodiments, the well_challenge object 225 has the following structure:

| Display Type | Type | Field Name |
|---|---|---|
| id | Text Field | field_id |
| Modified By ID | Text Field | modified_by_id |
| Owner ID | Text Field | field_owner_id |
| wellchallenge_description | Text Field | wellchallenge_description |
| wellchallenge_id | Text Field | wellchallenge_id |
| wellchallenge_name | Text Field | wellchallenge_name |
| Created By ID | Text Field | column1 |
| Created By | Lookup | created_id |
| Date Created | Date time | date_created |
| Date Modified | Date time | date_modified |
| Modified By | Lookup | modified_id |
| Object ID | Text Field | object_id |
| Owner | Lookup | owner_id |
| Record ID | Number | id |

In one or more embodiments, the simulation_dataset_well_info object 230 has the following structure:

| Display Type | Type | Field Name |
|---|---|---|
| simulation_dataset_id | Text Field | simulation_dataset_id |
| id | Text Field | field_id |
| Modified By ID | Text Field | modified_by_id |
| Owner ID | Text Field | field_owner_id |
| well_info_d | Text Field | well_info_id |
| Created By ID | Text Field | column1 |
| Created By | Lookup | created_id |
| Date Created | Date time | date_created |
| Date Modified | Date time | date_modified |
| Modified By | Lookup | modified_id |
| Object ID | Text Field | object_id |
| Owner | Lookup | owner_id |
| Record ID | Number | id |

In one or more embodiments, the well_info object 235 has the following structure:

| Title | Type | Field Name |
|---|---|---|
| id | Text Field | field_id |
| Modified By ID | Text Field | modified_by_id |
| Owner ID | Text Field | field_owner_id |
| wellinfo_description | Text Field | wellinfo_description |
| wellinfo_id | Text Field | wellinfo_id |
| wellinfo_name | Text Field | wellinfo_name |
| Created By ID | Text Field | column1 |
| Created By | Lookup | created_id |
| Date Created | Date time | date_created |
| Date Modified | Date time | date_modified |
| Modified By | Lookup | modified_id |
| Object ID | Text Field | object_id |
| Owner | Lookup | owner_id |
| Record ID | Number | id |

In one or more embodiments, the lithology object 237 has the following structure:

| Title | Display Type | Field Name |
|---|---|---|
| enddepth | Number | enddepth |
| simulation_dataset_id | Text Field | simulation_dataset_id |
| id | Text Field | field_id |
| lithology_description | Text Field | lithology_description |
| lithology_id | Text Field | lithology_id |
| lithology_name | Text Field | lithology_name |
| Modified By ID | Text Field | modified_by_id |
| Owner ID | Text Field | field_owner_id |
| startdepth | Number | startdepth |
| Created By ID | Text Field | column1 |
| Created By | Lookup | created_id |
| Date Created | Date time | date_created |
| Date Modified | Date time | date_modified |
| Modified By | Lookup | modified_id |
| Object ID | Text Field | object_id |
| Owner | Lookup | owner_id |
| Record ID | Number | id |

In one or more embodiments, the well_section object 250 has the following structure:

| Title | Display Type | Field Name |
|---|---|---|
| id | Text Field | field_id |
| Modified By ID | Text Field | modified_by_id |
| Owner ID | Text Field | field_owner_id |
| SECTIONDESCRIPTION | Text Field | sectiondescription |
| SECTIONID | Text Field | sectionid |
| SECTIONNAME | Text Field | sectionname |
| Created By ID | Text Field | column1 |
| Created By | Lookup | created_id |
| Date Created | Date time | date_created |
| Date Modified | Date time | date_modified |
| Modified By | Lookup | modified_id |
| Object ID | Text Field | object_id |
| Owner | Lookup | owner_id |
| Record ID | Number | id |

In one or more embodiments, the package object 255 has the following structure:

| Title | Display Type | Field Name |
|---|---|---|
| defaultValue | Number | defaultvalue |
| id | Text Field | field_id |
| Modified By | Text Field | modified_by_id |
| ID | | |
| optionValue | Number | optionvalue |
| Owner ID | Text Field | field_owner_id |
| packageOption | Text Field | packageoption |
| sectionid | Number | sectionid |
| Created By ID | Text Field | column1 |
| Created By | Lookup | created_id |
| Date Created | Date time | date_created |
| Date Modified | Date time | date_modified |
| Modified By | Lookup | modified_id |
| Object ID | Text Field | object_id |
| Owner | Lookup | owner_id |
| Record ID | Number | id |

In one or more embodiments, the item object 260 has the following structure:

| Title | Display Type | Field Name |
|---|---|---|
| id | Text Field | field_id |
| item_cost | Number | item_cost |
| item_description | Text Field | item_description |
| item_id | Text Field | item_id |
| item_name | Text Field | item_name |
| Modified By ID | Text Field | modified_by_id |
| Owner ID | Text Field | field_owner_id |
| packageOption | Text Field | packageoption |
| pic | Text Field | pic |
| psl | Number | psl |
| Created By ID | Text Field | column1 |
| Created By | Lookup | created_id |
| Date Created | Date time | date_created |
| Date Modified | Date time | date_modified |
| Modified By | Lookup | modified_id |
| Object ID | Text Field | object_id |
| Owner | Lookup | owner_id |
| Record ID | Number | id |

In one or more embodiments, the event object 275 has the following structure:

| Title | Display Type | Field Name |
|---|---|---|
| event_id | Text Field | event_id |
| event_name | Text Field | event_name |
| id | Text Field | field_id |
| Modified By | Text Field | modified_by_id |
| ID | | |
| Owner ID | Text Field | field_owner_id |
| Created By ID | Text Field | column1 |
| Created By | Lookup | created_id |
| Date Created | Date time | date_created |
| Date Modified | Date time | date_modified |
| Modified By | Lookup | modified_id |
| Object ID | Text Field | object_id |
| Owner | Lookup | owner_id |
| Record ID | Number | id |

In one or more embodiments. the option object 280 has the following structure:

| Display Type | Type | Field Name |
|---|---|---|
| cost | Number | cost |
| description | Text Field | description |
| details | Text Field | details |
| id | Text Field | field_id |
| Modified By ID | Text Field | modified_by_id |
| optionId | Text Field | optionid |
| optionName | Text Field | optionname |
| Owner ID | Text Field | field_owner_id |
| payOffPenalty | Text Field | payoffpenalty |
| Created By ID | Text Field | column1 |
| Created By | Lookup | created_id |
| Date Created | Date time | date_created |
| Date Modified | Date time | date_modified |
| Modified By | Lookup | modified_id |
| Object ID | Text Field | object_id |
| Owner | Lookup | owner_id |
| Record ID | Number | id |

In one or more embodiments, the role object 290 has the following structure:

| Display Type | Type | Field Name |
|---|---|---|
| id | Text Field | field_id |
| Modified By ID | Text Field | modified_by_id |
| Owner ID | Text Field | field_owner_id |
| ROLE_COST | Number | role_cost |
| ROLE_DESCRIPTION | Text Field | role_description |
| ROLE_ID | Number | role_id |
| ROLE_NAME | Text Field | role_name |
| Created By ID | Text Field | column1 |
| Created By | Lookup | created_id |
| Date Created | Date time | date_created |
| Date Modified | Date time | date_modified |
| Modified By | Lookup | modified_id |
| Object ID | Text Field | object_id |
| Owner | Lookup | owner_id |
| Record ID | Number | id |

In one or more embodiments, the simulation_dataset object 205 logically encapsulates and links to the information necessary to create user simulations of a particular training scenario and a specifically designed well or wells. Thus, in one or more embodiments, all simulations that are played by users are constrained by the set of events chosen at design time when the data set is constructed. In one or more embodiments, this also includes each set of options that are available to the user for every such event. However, in one or more embodiments, each user's actions (i.e. selection of a specific option given the available set of options for that event) are unique to that simulation leading to diverging payoffs and subsequent training induced learning.

In one or more embodiments, a large number and variety of such simulation data sets are created in a real-world training scenario. In one or more embodiments, different data sets have different combinations of any or all of these data, even for the same well or wells, for different training scenarios. Thus, in one or more embodiments, this data driven approach to design time simulation data set specification enables easy configuration, maintenance, and large scale extension.

In one or more embodiments, the simulator is integrated with enterprise systems to maintain master lists of items, packages, well information, and to create simulation data sets “on demand.”

In one or more embodiments, selection of external conditions, well events, costs, and payoffs are randomized to further simulate real-world conditions. Such randomness can be introduced at any stage of the simulation, including at initialization, in response to real-world events, in response to user actions or choices. In one or more embodiments, events are serially played as per the data set with no randomization and different results are caused by different choices users make at each event, with each choice having different costs and payoffs. In one or more embodiments, some of these costs and payoffs vary based on the package selections made.

In one or more embodiments, enhanced reporting provides training feedback, improves training effectiveness, and provides information to further refine the simulation_dataset 205.

In one or more embodiments, the number of well sections, the packages available for selection for each chosen well_section, the items included in a package, the SME recommendations associated with a package or a package item, the events that occur while drilling or completing the well or wells (or any other activity related to the well or wells), are all specified when the simulation data set is created.

In one or more embodiments, these can be changed by updating and/or augmenting the repository, i.e. by revising the simulation_dataset 205.

At a high level, in one or more embodiments, a generic simulation flow as facilitated and managed by the application user proceeds as follows:
1. An authenticated trainee/user selects a simulation data set.
2. A new user simulation is started (or prior simulation resumed).
3. SMEs on the team are picked.
4. Selections of a package of equipment and services for each planned well section are picked
5. Simulation of drilling activity begins, with users making decisions while drilling progresses from well event to well event until the simulation concludes.
6. User simulation data (including specific event options selected) are persisted in the repository for reporting and analysis.

In a more detailed description of one or more embodiments of a high-level workflow, illustrated in FIG. 3, a simulation starts (block 305) and a simulation data set is selected (block 310). In one or more embodiments, a new simulation is then started (block 315). In one or more embodiments, a user then selects SMEs (block 320). In one or more embodiments, the user then selects packages (block 325). In one or more embodiments, these and subsequent selections influence the path taken through the simulation, the packages and options presented later in the simulation, and the cost and time associated with events encountered as the simulation progresses. In one or more embodiments, the addition of randomness increases the number of paths the simulator may follow and reduces the possibility of duplication of simulator experiences by the user. In one or more embodiments, the degree of similarity between two simulator experiences when the user makes similar choices is driven by the degree of randomness used.

In one or more embodiments, event data is then displayed to the user (block 330). In one or more embodiments, at this point, the simulation can be saved (block 335). In one or more embodiments, resuming a simulation (block 340) restarts the simulation at the display event data block (block 330). In one or more embodiments, the user then makes an event decision (block 345). In one or more embodiments, the simulator updates calculations (block 350) and updates charts (block 355). In one or more embodiments, if there are more events (360), the simulation returns to the display event data block (block 330). In one or more embodiments, if there are no more events, the simulation stops (block 365). In one or more embodiments, the simulator then reports statistics (block 370).

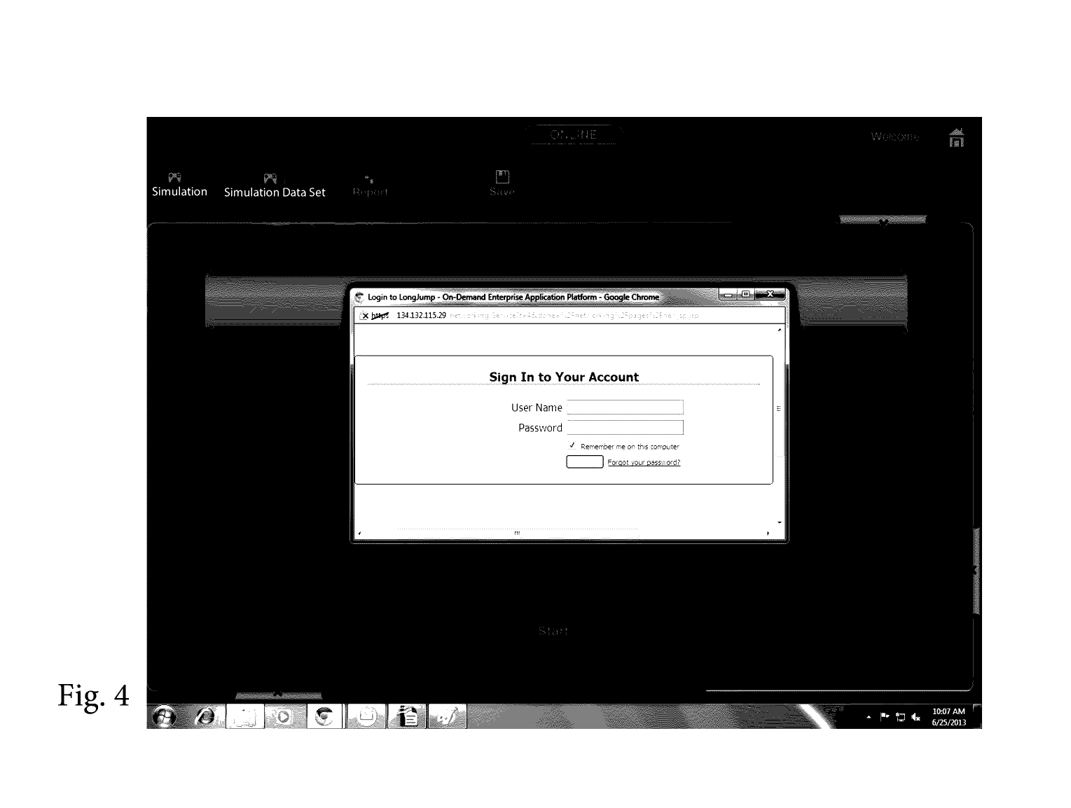

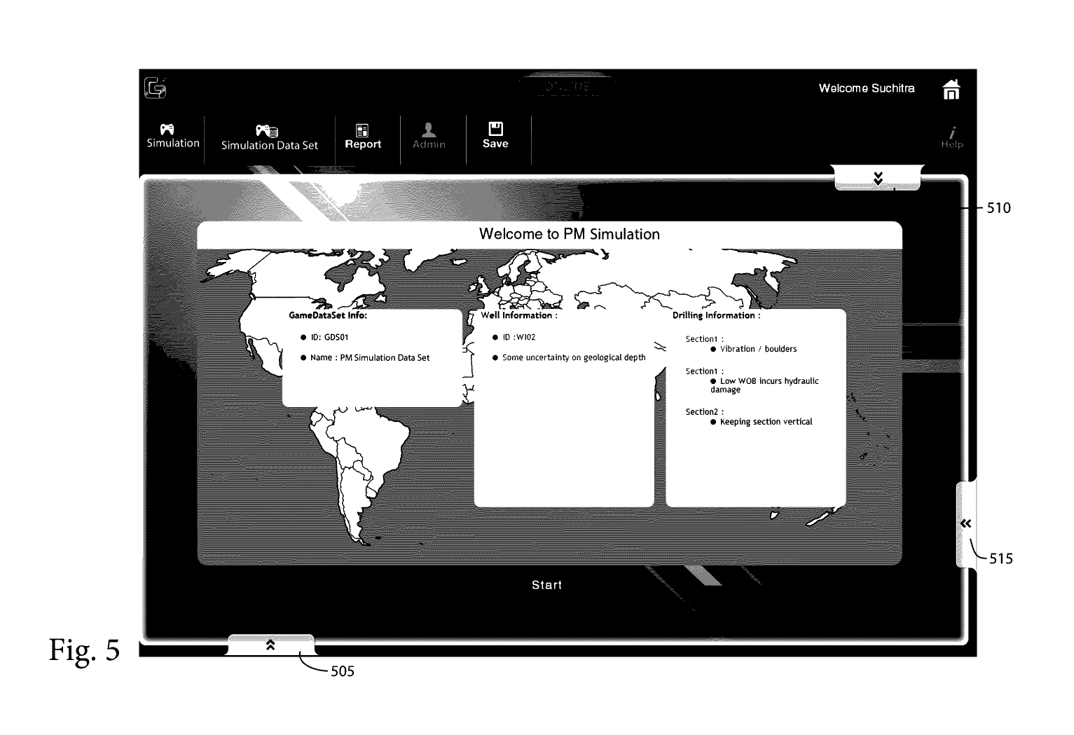

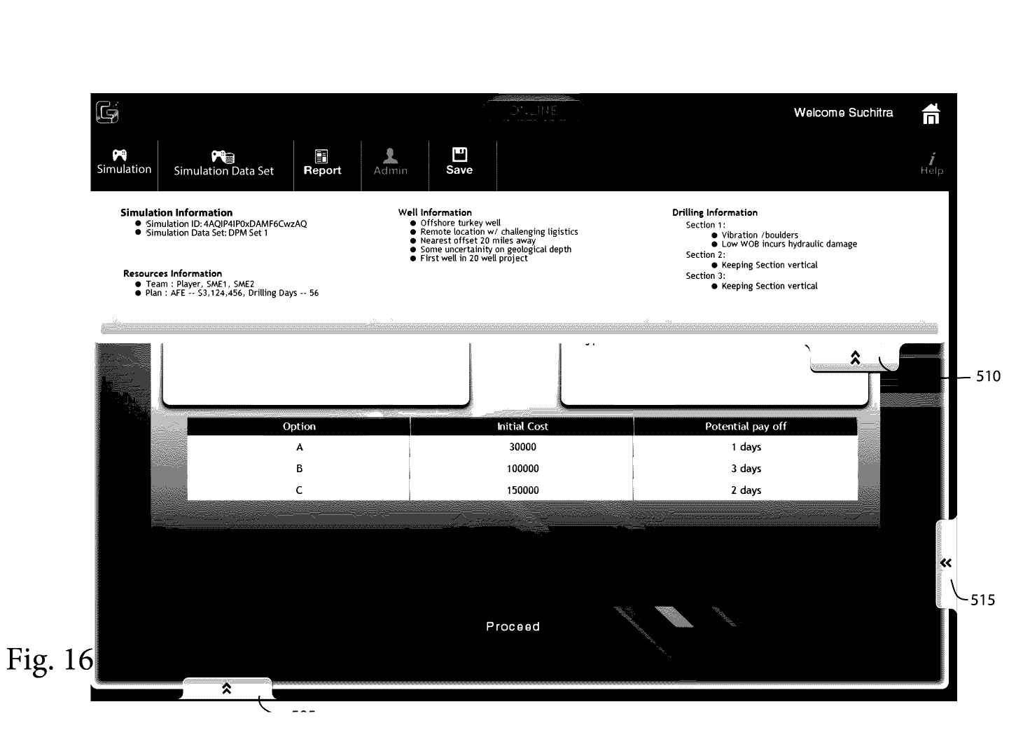

A detailed description of one or more embodiments of a graphical user interface (UI) is now described in reference to FIGS. 4-18. In one or more embodiments, when the simulator is launched a home page is displayed along with a pop-up window in which the user is required to provide credentials to login to the simulator, as shown in FIG. 4. In one or more embodiments, upon entry, the user's name is stored as a person object 285 (see FIG. 2). In one or more embodiments, upon authorization by accessing the person object 285, the user's name is retrieved from the person object 285 and displayed on a homepage, as illustrated in FIG. 5. In one or more embodiments, as illustrated in FIG. 5, the homepage shows SimulationDataSet information, Well information, and Drilling information, which are read from the simulation_dataset object 205, the well_info object 235, and the lithology object 235 (see FIG. 2), respectively. In one or more embodiments, a double arrow button 505 at the bottom of the screen, a double arrow button at 510 at the top of the screen, and a double arrow button 515 on the right side of the screen provide for the display of additional information as described below.

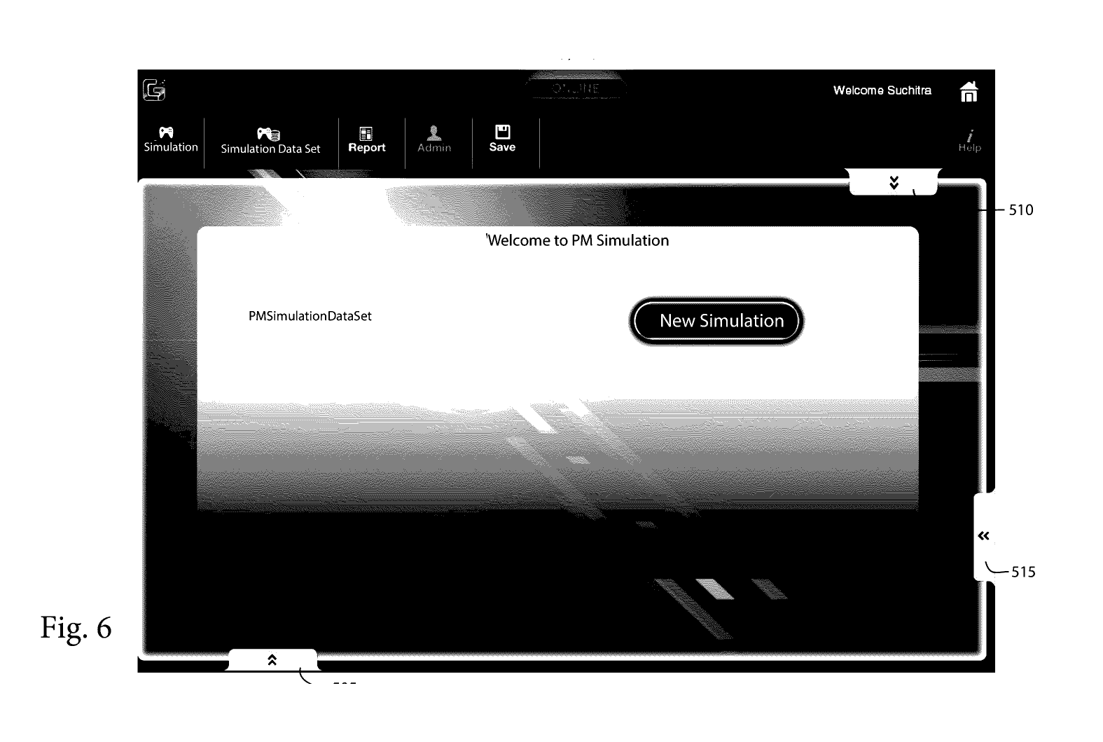

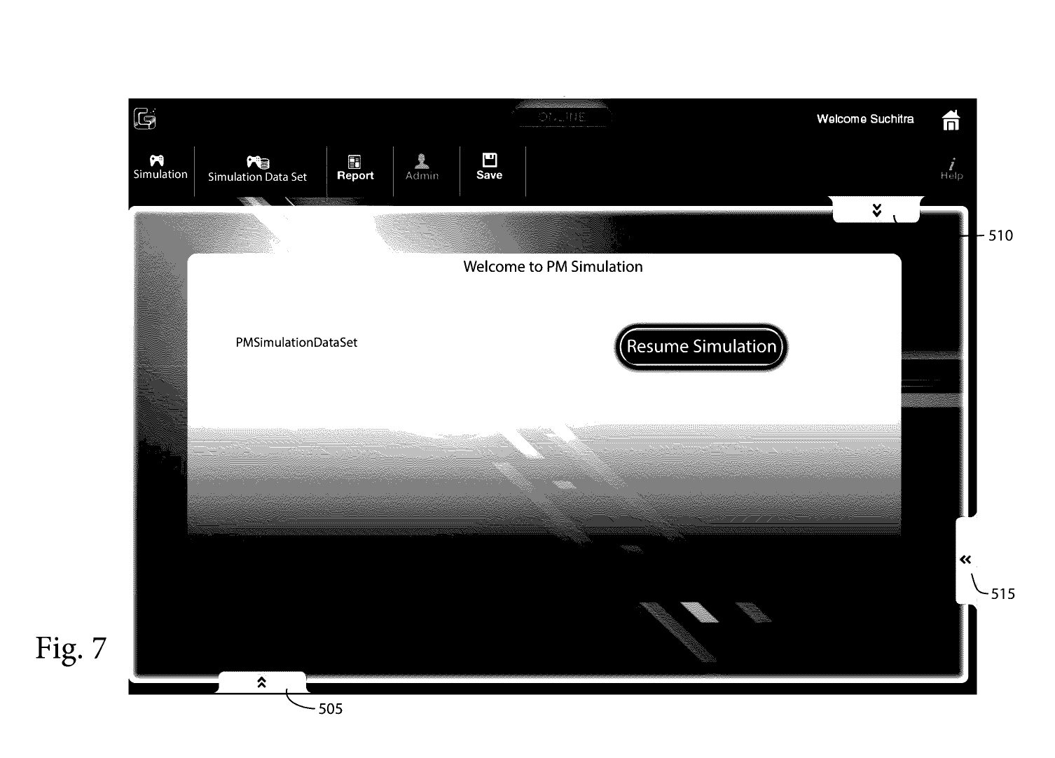

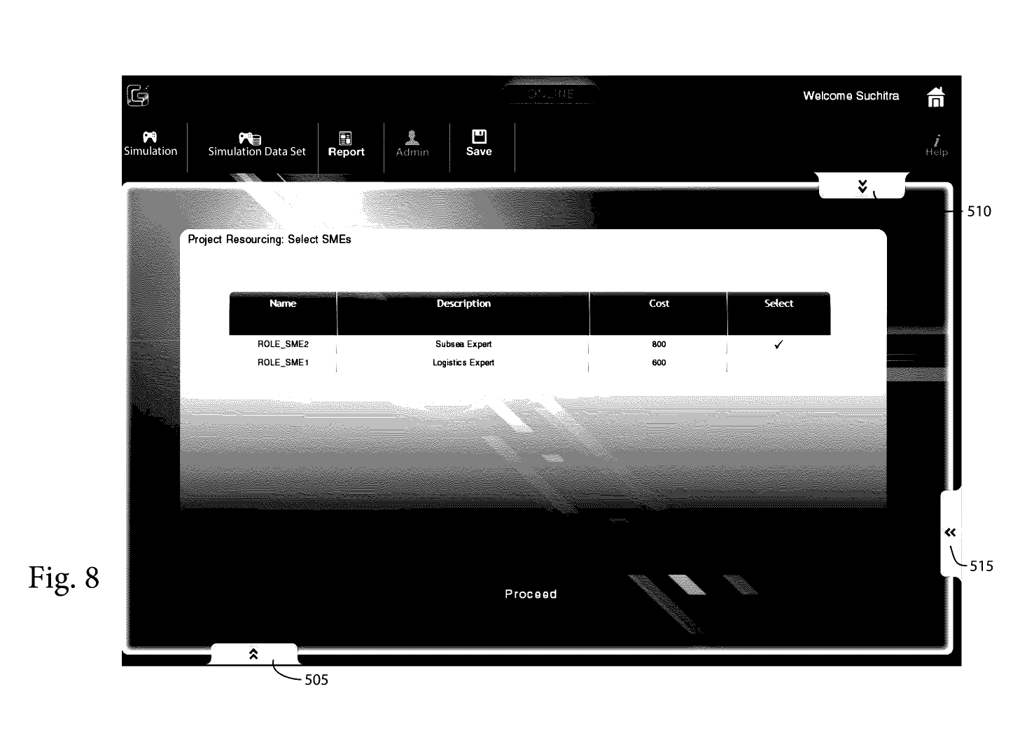

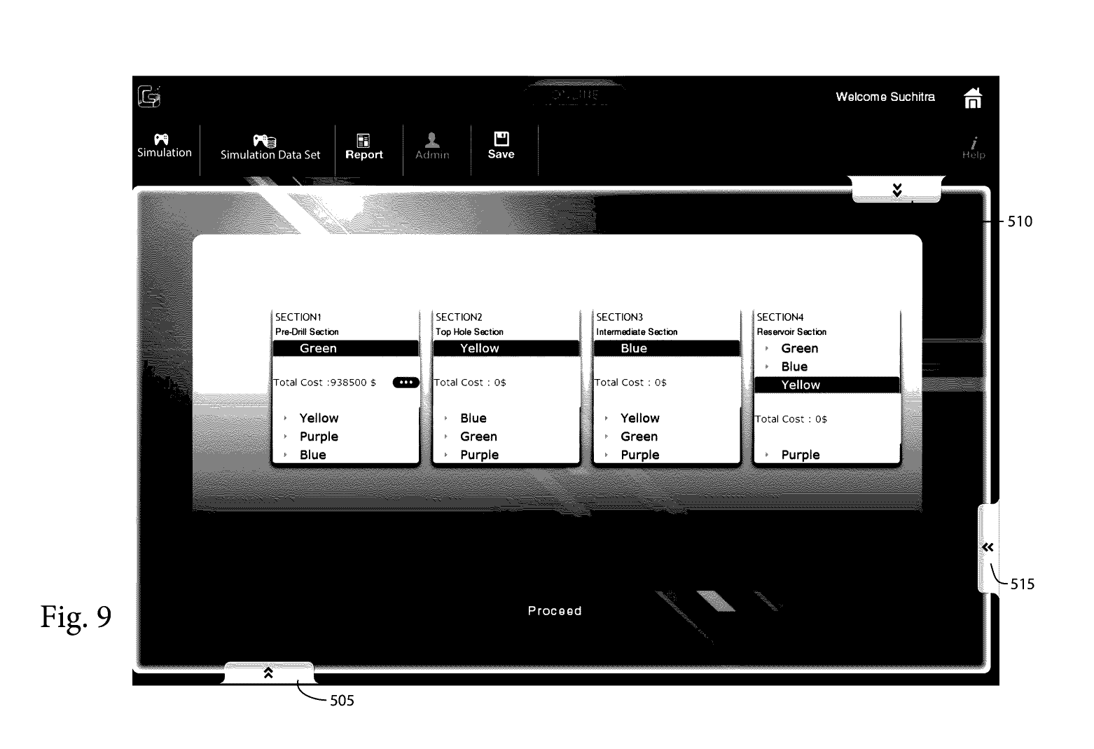

In one or more embodiments, upon pushing the Start button illustrated at the bottom of the screen illustrated in FIG. 5, the simulator will transition to a new screen in which a “New Simulation” button will be displayed, as shown in FIG. 6. If there is already a simulation in the resume state, the user will see a “Resume Simulation” button on the new screen, as shown in FIG. 7. Clicking the Resume Simulation button will resume the existing in-progress simulation. Returning to FIG. 6, pressing the New Simulation button will launch the Select SMEs screen where the user can select one or more subject matter experts, as shown in FIG. 8. Clicking on the Proceed button at the bottom of FIG. 8 causes the user selection of SMEs to be stored and cause the simulation to transition to the package selection screen, illustrated in FIG. 9.

In one or more embodiments, the package selection screen includes menus by which packages (such as green, yellow, purple, and blue) can be selected for each of 4 well sections (pre-drill, top hole, intermediate, and reservoir). It will be understood that the number of packages and the number of well sections can be larger or smaller than the number shown in FIG. 9.

In one or more embodiments, selecting one of the packages will cause the cost of the selected package, calculated from information retrieved from the simulation_dataset_section_package object 235, the well_section object 250, the package object 244 and the item object 260, to be displayed along with a button (represented in the example shown in FIG. 9 by the ellipsis shown under the selected Green package under the Pre-Drill Section) that allows additional information about the package, such as detailed information about the items included in the selected package, retrieved from the same sources, to be displayed. For example, the cost of the Green package under the Pre-Drill Section is calculated to be $938,500.

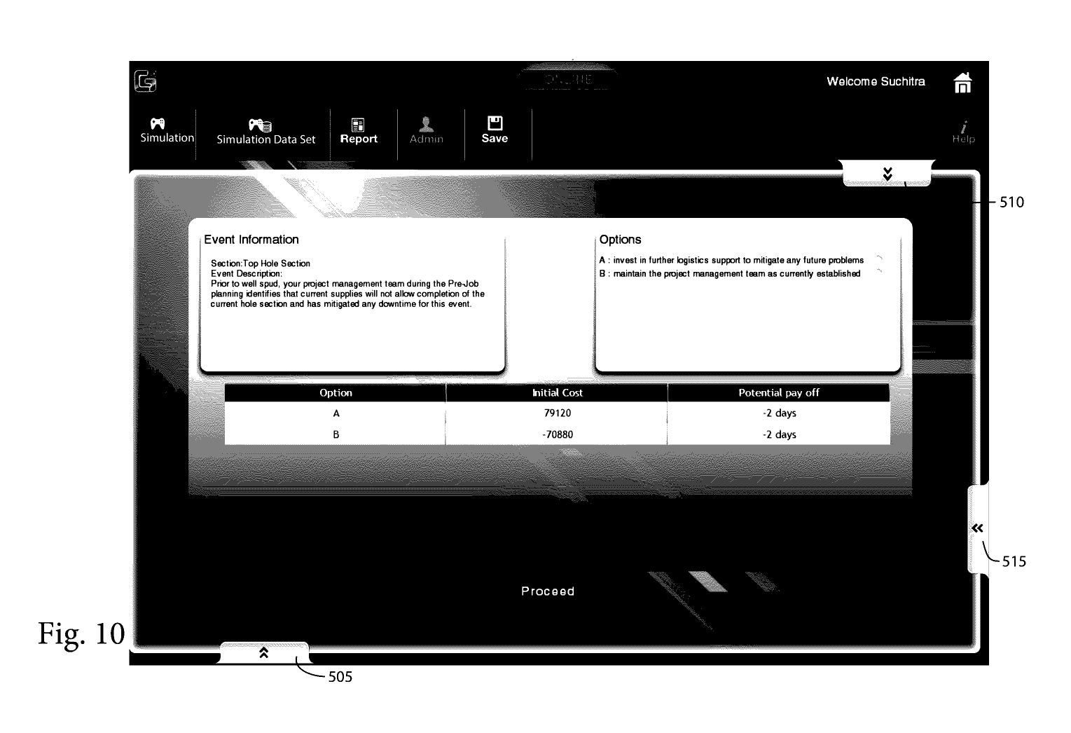

In one or more embodiments, upon clicking the Proceed button at the bottom of FIG. 9, the Event Options screen will be launched, as shown in FIG. 10. The events and/or the event options presented for each event are dependent upon the previous selections by the user and/or any randomness that has been included in the simulation.

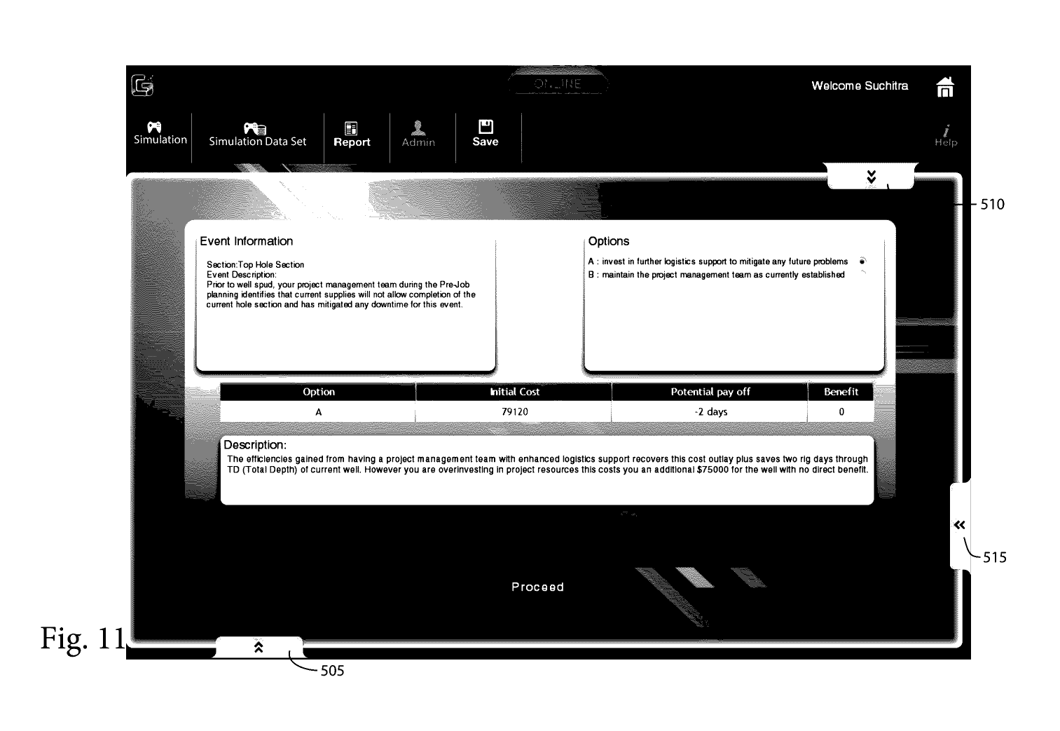

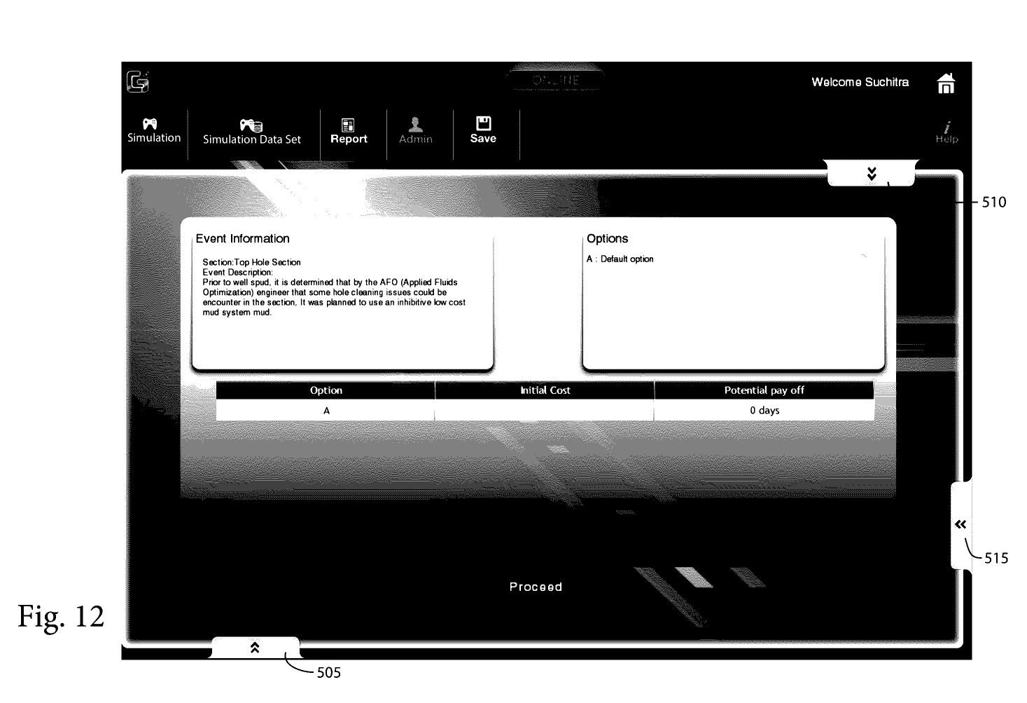

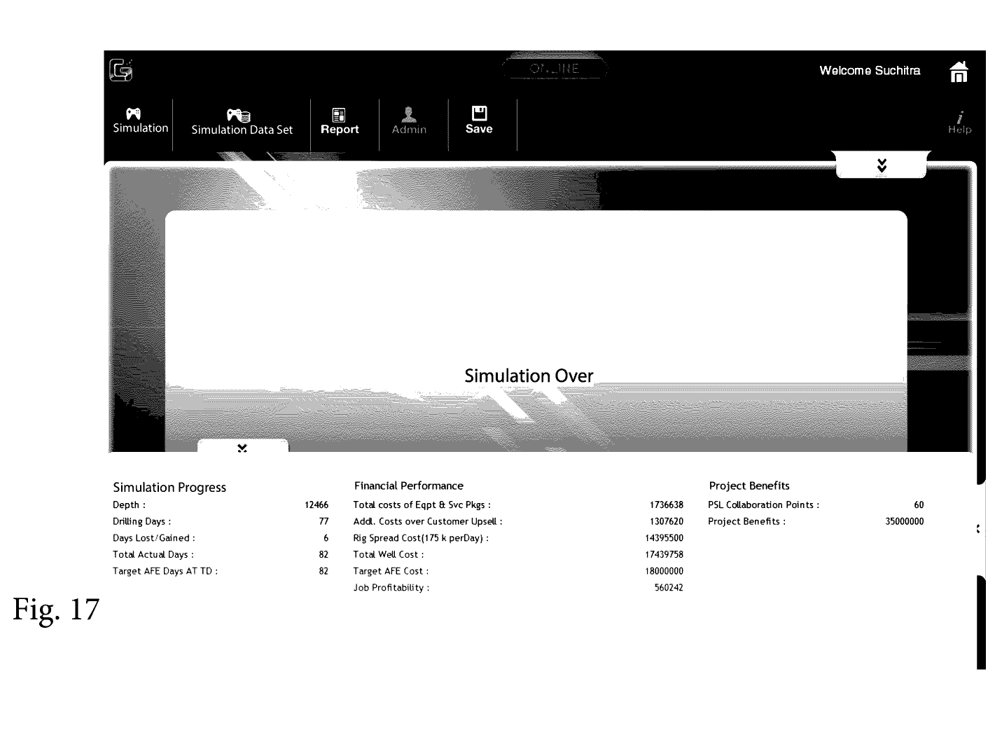

In one or more embodiments, the Event Options screen includes an Event Information block, which includes a description of an event drawn from the simulation_dataset_event_option object 270 and the event object 275 and one or more options for responding to the event drawn from the option object 280. In one or more embodiments, the initial cost and potential payoff, drawn from the option object 280, are also displayed. In one or more embodiments, additional information for an option is displayed, as shown in FIG. 11, upon selection of one of the options. For example, FIG. 11 illustrates the results of selecting option A in FIG. 10. In one or more embodiments, upon clicking the Proceed button at the bottom of FIG. 10 or FIG. 11, the next Event Options screen, illustrated in FIG. 12, will be displayed, which allows the selection of additional options, thereby allowing one or more options to be selected for each section of the well. Upon selection of the last option, the Simulation Over screen, shown in FIG. 17, is displayed.

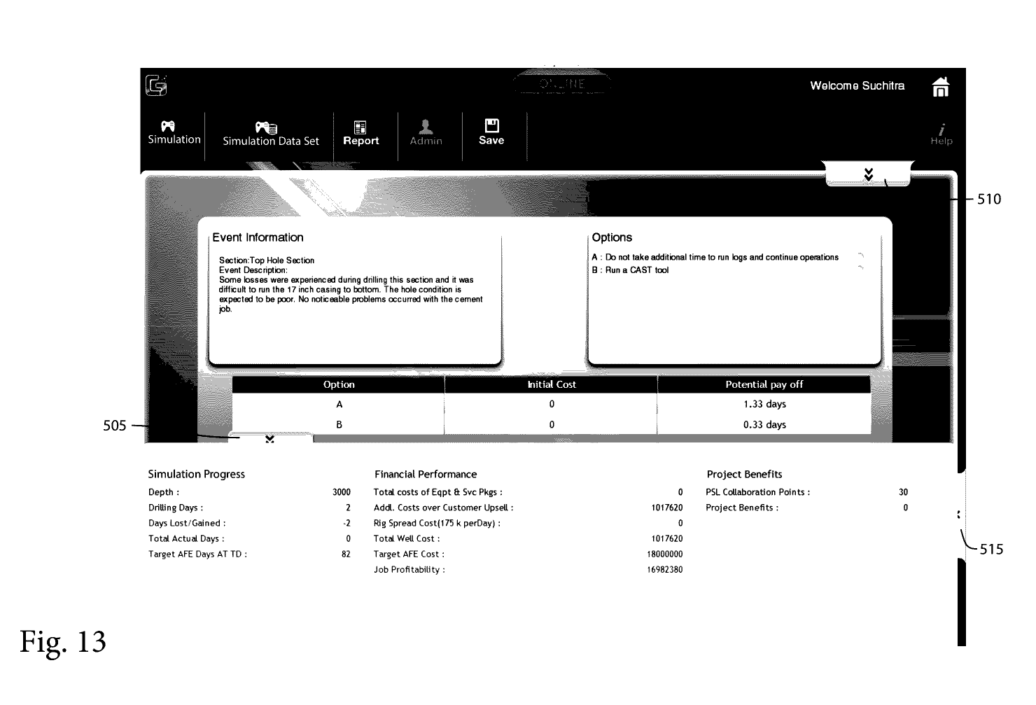

In one or more embodiments, simulation progress is calculated and is displayed on a bottom panel, as shown in FIG. 13, which is accessed by pressing the double-arrow button 505 at the bottom of the screen (shown in FIGS. 5-12 and in FIG. 13 in a different location). In one or more embodiments, the simulation progress panel includes a Simulation Progress area, which includes the depth, drilling days, days lost/gained, total actual days, and target AFE days at total depth (TD). In one or more embodiments, the simulation progress panel includes a Financial Performance area which includes the total cost of equipment (Eqpt) and service packages (Svc Pkgs), additional costs over customer upsell, the rig spread cost, the total well cost, the target AFE cost, and the job profitability. In one or more embodiments, the simulation progress panel includes a Project Benefits area, which includes a score for product service line (PSL) collaboration points (i.e., the more PSL involvement the more collaboration points are awarded) and project benefits.

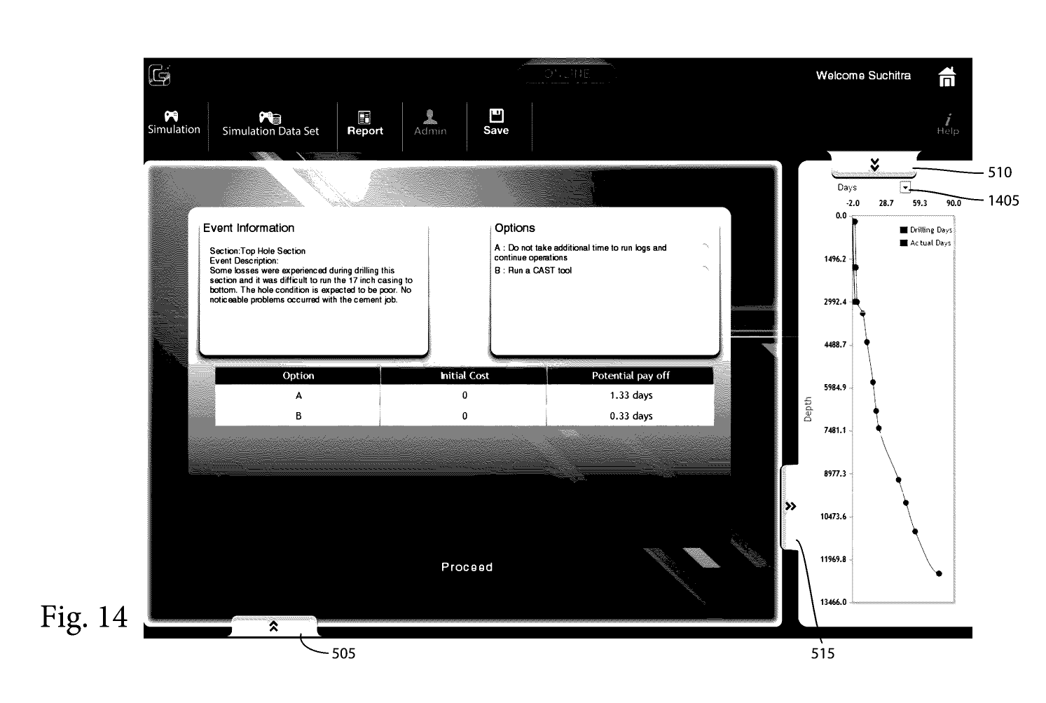

In one or more embodiments, pressing the double arrow button 515 causes a days versus depth graph to be plotted and displayed in a right panel, as illustrated in FIG. 14. In one or more embodiments, the days versus depth plot shows the depth reached on each day of drilling. In one or more embodiment, the more vertical the plot, the better the user's performance on the simulation. In one or more embodiments, the days-versus-depth plot includes a planned plot and an actual plot to allow illustration of planned versus actual progress.

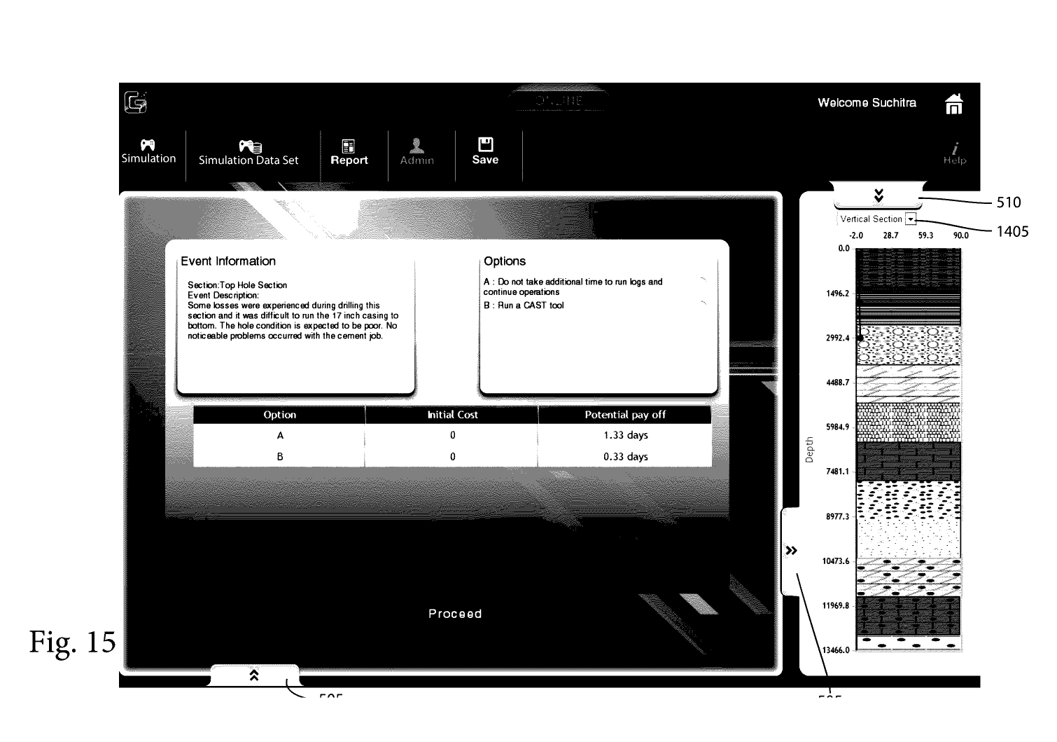

In one or more embodiments, a different representation of well progress can be selected using the drop down menu 1405 shown in FIGS. 14 and 15. In one or more embodiments, a second selection on the drop-down menu 1405 is a vertical section representation, as shown in FIG. 15. In this representation, in one or more embodiments, the depth of the well is shown as a line with dots representing the depth of the well at the end of each day and the lithography to be drilled through for the well is illustrated.

In one or more embodiments, as mentioned above, upon selection of all of the options for particular simulation, the Simulation Over screen, as illustrated in FIG. 17 is shown. In addition simulation progress data is automatically synchronized to a database when the user is in the online mode.

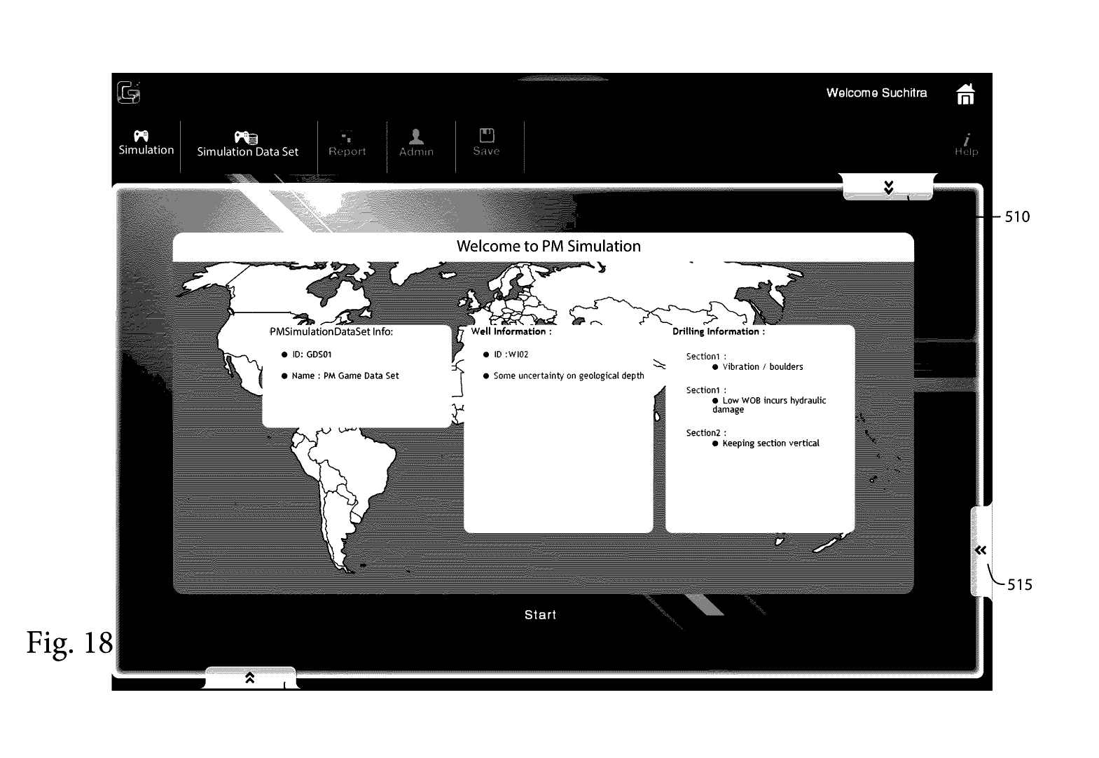

In one or more embodiments, if the user is in the offline mode (i.e., when the user is using the simulator without a network connection or access to the database), then the simulation progress for each simulation will be saved in the browser local storage and simulation progress will be synchronized to the database when the user switches to the online mode. In one or more embodiments, the screens for the offline mode are the same as the screens for the online mode illustrated in FIGS. 5 through 17, except that the word “OFFLINE” is shown at the stop of the screen, as illustrated in FIG. 18.

In one or more embodiments, the calculations performed as a simulation proceeds are now discussed. In one or more embodiments, when a simulation_dataset is chosen, as shown in FIG. 6, the following data is picked up:

Target AFE days at TD—82

Target AFE cost=180,000,000

In one or more embodiments, values from the event option object 280 are picked up on the basis of the event and the option selected for that event. In one or more embodiments, only rounded values will be displayed. In one or more embodiments, for every event, values are added as shown in the table below:

| Attribute | Calculation |
|---|---|
| Depth | Depth + EVENT_OPTION.MEASUREDEPTH |
| Drilling Days | Drilling Days + EVENT_OPTION.AFEDAYS |
| Days Lost/Gained | Days lost/gained + EVENT_OPTION.DAYSLOST |
| Total Actual Days | Drilling Days + Days Lost/Gained |
| Target AFE days | 82 remains same |
| AT TD | |
| Total Costs of | Total Costs of Eqpt & Svc Pkgs + |
| Eqpt & Svc Pkgs | (EVENT_OPTION.AFEDAYS + |
| | EVENT_OPTION.DAYSLOST) * |
| | (PACKAGE_MULTIPLIER.MULTIPLIER |
| | (BASED on SECTION and PACKAGE id)) |
| Addl. Cost Over | Addl. Cost Over customer upsell + |
| customer upsell | EVENT_OPTION.ADDITIONALEQP |
| Rig Spread Cost | RIGSPREADCOSTS_MULTIPLIER. |
| | RIGSPREADCOSTSMULTIPLIER * |
| | (Drilling Days + Days Lost/Gained) |
| Total Well Cost | Addl. Cost Over customer upsell + |
| | (RIGSPREADCOSTS_MULTIPLIER. |
| | RIGSPREADCOSTSMULTIPLIER * |
| | (Drilling Days + Days Lost/Gained)) + |
| | Total Costs of Eqpt & Svc Pkgs |
| Target AFE cost | 18000000 remains same |
| PSL collaboration | PSL collaboration points + |
| points | EVENT_OPTION.PSLCOLLABORATIONPOINTS |
| Project benefits | Project benefits + EVENT_OPTION. |
| | PROJECTBENEFITS |

The profit and loss calculation (i.e., job profitability) is calculated as Target AFE cost−Total Well cost.

In one or more embodiments, the SME selector, package selection, option selection, and results of multiple iterations of the simulator are subjected to, for example, a Monte Carlo analysis (or another statistical analysis involving the use of a large number of results) and the result of that analysis is used to arrive at a recommendation of the approach to be used in solving a problem represented in the simulator. For example, in one or more embodiments, the multiple iterations of simulator package selections, option selections and results are analyzed to determine the most likely SME selector, package selection, and option selection to maximize profit, to minimize the time necessary to drill the well, to minimize cost, or to maximize or minimize another attribute. In one or more embodiments, such recommendations can be used as opinions, provided, for example, by SMEs, to further inform the training experience. Further, in one or more embodiments, the data gathered during a number of simulations can be saved and used to inform decision making in non-training situations or in searchable knowledge bases.

References in the specification to “one or more embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention include features, methods or processes that may be embodied within machine-executable instructions provided by a machine-readable medium. A computer-readable medium includes any mechanism which provides (i.e., stores and/or transmits) information in a form accessible by a machine (e.g., a computer, a network device, a personal digital assistant, manufacturing tool, any device with a set of one or more processors, etc.). In an exemplary embodiment, a computer-readable medium includes non-transitory volatile and/or non-volatile media (e.g., read only memory (ROM), random access memory (RAM), magnetic disk storage media, optical storage media, flash memory devices, etc.), as well as transitory electrical, optical, acoustical or other form of propagated signals (e.g., carrier waves, infrared signals, digital signals, etc.).

Such instructions are utilized to cause a general or special purpose processor, programmed with the instructions, to perform methods or processes of the embodiments of the invention. Alternatively, the features or operations of embodiments of the invention are performed by specific hardware components which contain hard-wired logic for performing the operations, or by any combination of programmed data processing components and specific hardware components. One or more embodiments of the invention include software, data processing hardware, data processing system-implemented methods, and various processing operations, further described herein.

One or more figures show block diagrams of systems and apparatus for a simulator, in accordance with one or more embodiments of the invention. One or more figures show flow diagrams illustrating simulator operations, in accordance with one or more embodiments of the invention. The operations of the flow diagrams are described with references to the systems/apparatus shown in the block diagrams. However, it should be understood that the operations of the flow diagrams could be performed by embodiments of systems and apparatus other than those discussed with reference to the block diagrams, and embodiments discussed with reference to the systems/apparatus could perform operations different than those discussed with reference to the flow diagrams.

In view of the wide variety of permutations to the embodiments described herein, this detailed description is intended to be illustrative only, and should not be taken as limiting the scope of the invention. What is claimed as the invention, therefore, is all such modifications as may come within the scope and spirit of the following claims and equivalents thereto. Therefore, the specification and drawings are to be regarded in an illustrative rather than a restrictive sense.

The word “coupled” herein means a direct connection or an indirect connection.

The text above describes one or more specific embodiments of a broader invention. The to invention also is carried out in a variety of alternate embodiments and thus is not limited to those described here. The foregoing description of an embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A method comprising:
a processor providing through a graphical user interface (GUI):
an identification of a subject matter expert (SME), and
an SME selector through which the SME can be selected;
the processor receiving through the GUI an SME selector indicating whether or not the SME has been selected;
the processor providing through the GUI a package selector for each of a plurality of package categories;
a processor receiving through the GUI a package selection for each of the plurality of package categories;
the processor providing through the GUI:
a description of an event, the event being selected based on the package selections and a simulation stage, and
descriptions of a plurality of options to respond to the event, wherein the plurality of options is based on the SME selector, the package selectors, and the simulation stage;
the processor receiving through the GUI a selection of one of the plurality of options;
the processor processing the option, the package selections, the SME selector, and the simulation stage to determine an outcome; and
the processor displaying the outcome on the GUI.

2. The method of claim 1 wherein:
the plurality of package categories comprises:
a pre-drill package category,
a top hole section package category.
an intermediate section package category, and
a reservoir section package category.

3. The method of claim 1 wherein the package selector comprises a menu.

4. The method of claim 1 further comprising:
the processor receiving through the GUI a tentative selection of one of the plurality of options, and
the processor providing through the GUI a description of the tentatively selected one of the plurality of options.

5. The method of claim 1 wherein the outcome comprises a graph showing a days versus depth graph showing the depth that a well has reached on each day.

6. The method of claim 1 wherein the outcome comprises a vertical section showing a lithography.

7. (canceled)

8. The method of claim 1 wherein selection of the event is based on a random variable in addition to the package selections and the simulation stage.

9. A non-transitory computer-readable medium, on which is recorded a computer program, the program comprising executable instructions that, when executed, cause a processor to perform a method comprising:
providing through a graphical user interface (GUI):
an identification of a subject matter expert (SME), and
an SME selector through which the SME can be selected;
receiving through the GUI an SME selector indicating whether or not the SME has been selected;
providing through the GUI a package selector for each of a plurality of package categories;
receiving through the GUI a package selection for each of the plurality of package categories;
providing through the GUI:
a description of an event, the event being selected based on the package selections and a simulation stage, and
descriptions of a plurality of options to respond to the event, wherein the plurality of options is based on the SME selector, the package selectors, and the simulation stage;
receiving through the GUI a selection of one of the plurality of options;
processing the option, the package selections, the SME selector, and the simulation stage to determine an outcome; and
displaying the outcome on the GUI.

10. The non-transitory computer-readable medium of claim 9 wherein:
the plurality of package categories comprises:
a pre-drill package category,
a top hole section package category.
an intermediate section package category, and
a reservoir section package category.

11. The non-transitory computer-readable medium of claim 9 wherein the package selector comprises a menu.

12. The non-transitory computer-readable medium of claim 9, wherein the method further comprises:
receiving through the GUI a tentative selection of one of the plurality of options, and
providing through the GUI a description of the tentatively selected one of the plurality of options.

13. The non-transitory computer-readable medium of claim 9 wherein the outcome comprises a graph showing a days versus depth graph showing the depth that a well has reached on each day.

14. The non-transitory computer-readable medium of claim 9 wherein the outcome comprises a vertical section showing a lithography.

15. The non-transitory computer-readable medium of claim 9 wherein the outcome comprises an analysis of the financial performance of the simulation given the SME selector, the package selections, and the selection of the one of the plurality of options.

16. (canceled)

17. A method comprising:
a processor executing a plurality of oil field service project management simulations, each execution comprising:
the processor providing through a graphical user interface (GUI):
an identification of a subject matter expert (SME), and
an SME selector through which the SME can be selected,
the processor receiving through the GUI an SME selector indicating whether or not the SME has been selected,
the processor providing through the GUI a package selector for each of a plurality of package categories,
a processor receiving through the GUI a package selection for each of the plurality of package categories,
the processor providing through the GUI:
a description of an event, the event being selected based on the package selections and a simulation stage, and
descriptions of a plurality of options to respond to the event, wherein the plurality of options is based on the SME selector, the package selectors, and the simulation stage,
the processor receiving through the GUI a selection of one of the plurality of options,
the processor processing the option, the package selections, the SME selector, and the simulation stage to determine an outcome,
the processor displaying the outcome on the GUI,
the processor storing the SME selector, the package selector for each of the package categories, the selection of the one of the plurality of options, and the outcome in one of a plurality of simulator execution packages;
the processor performing a statistical analysis of the plurality of simulator execution packages to produce a suggested SME selector, a suggested package selection, and a suggested option selection to achieve a desired result.

18. The method of claim 17 wherein the statistical analysis comprises a Monte Carlo analysis.

19. The method of claim 17 further comprising:
using the suggested SME selector, the suggested package selection, and the suggested option selection to inform decision-making in a non-training oil field service project management situation.

20. The method of claim 17 further comprising:
using the suggested SME selector, the suggested package selection, and the suggested option selection to populate a knowledge base.

21. The method of claim 17 further comprising:
using the suggested SME selector, the suggested package selection, and the suggested option selection to guide future oil field service project management training.

22. The method of claim 17 wherein the desired result is one of maximum profit, minimum cost, and minimum time to perform the oil field service project.
